(19) United States
(12) Patent Application Publication
(10) Pub. No.: US 2009/0322694 A1
(43) Pub. Date: Dec. 31, 2009

(54) MESSAGE PROCESSING SYSTEM AND METHOD

(75) Inventor: WEN-HSI HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/482,464

(22) Filed: Jun. 11, 2009

(30) Foreign Application Priority Data
Jun. 27, 2008 (CN) 200810302384.7

(51) Int. Cl. G06F 3/041

(52) U.S. Cl. 345/173

(57) ABSTRACT

A computer-based message processing system and method inputs an original image by using a touch panel of a first communication device, retrieves the original image, and encodes the original image to obtain a plurality of data packets. The system and method further compresses the data packets to generate a message, and transmits the message to a second communication device, receives the message by the second communication device, decodes the message to obtain the original image, and displays the obtained original image on a display of the second communication device.

### BACKGROUND

1. Technical Field

Embodiments of the present disclosure are related to messages managing, and particularly to a message processing system and method using at least two electronic devices.

2. Description of Related Art

Messaging services have become one of the major applications for people to communicate with each other. The Multimedia Message Service (MMS) has being developed and standardized to deliver rich communication contents, such as images and audio/video clips. The Instant Messaging (IM) service allow users to exchange rich messages instantly. Generally, users may input a message by writing/drawing on a touch panel of a first mobile device through a touch pen or a finger, and send the input message to a second mobile device. The second mobile device receives the input message, and displays the input message on a display interface, however, the displayed message is not displayed as it originally wrote/drew.

What is needed, therefore, is an improved system and method for processing message to overcome the above-stated problems.

### BRIEF DESCRIPTION OF THE DRAWINGS

FIG. 1 is a block diagram of one embodiment of a message processing system installed in a first communication device and a second communication device.

FIG. 2 is a flowchart of one embodiment of a message processing method using the first communication device and the second communication device.

FIG. 3 is a schematic diagram showing an original image on the first communication device and an obtained original image on the second communication device.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

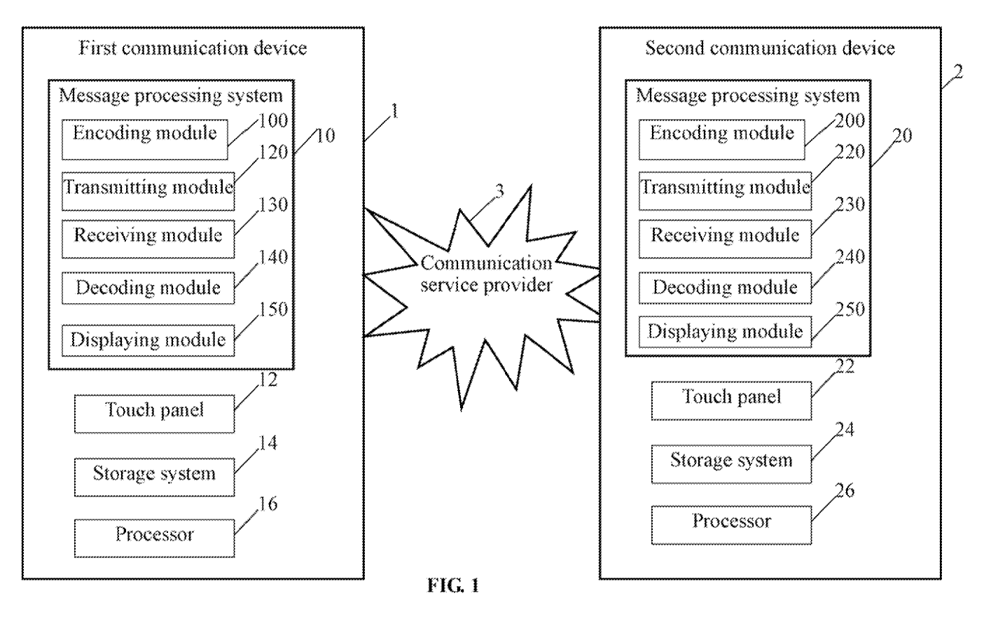

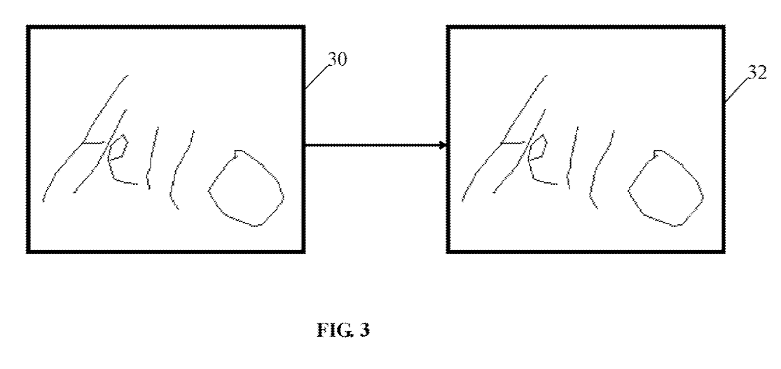

FIG. 1 is a block diagram of one embodiment of a message processing system 10 of a first communication device 1. For the purpose to describe conveniently, it is supposed that the first communication device 1 encodes an original image 30 (as show in FIG. 3) into a plurality of data packets, compresses the plurality of data packets to obtain/generate a message, and transmits the message to the second communication device 2 via a communication service provider 3. The communication service provider 3 may be China Mobile, China Unicom, China telecom and so on. The second communication device 2 receives and decodes the message to obtain the original image 32 (shown in FIG. 3). In one embodiment, the original image is written/drawn a touch panel 12 of the first communication device 1 by user input. In other embodiment, the original image may be inputted by a standard keyboard/keypad of the communication device 1. The original image 30 may be words, graphs, or any other suitable symbols.

Depending on the embodiment, the first communication device 1 and the second communication device 2 are installed with the same components having the same functions, such as the message processing systems 10, 20, the touch panels 12, 22, storage systems 14, 24 and processors 16, 26 correspondingly. The first communication device 1 includes a touch panel 12, a storage system 14, and a processor 16. In one embodiment, the touch panels 12,22 may include a resistive film type and an electrostatic capacitive type.

The storage system (14, 24) stores one or more programs, such as computerized codes of the message processing system (10, 20), programs of an operating system, and other applications. In one embodiment, the first communication device 1 may be a mobile phone or a personal digital assistant, and the storage system 14 may be an external storage card, e.g., a smart media card, a secure digital card, a compact flash card, or any other type of memory card. The processor 16 executes programs of the message processing system 10 and the other applications, to provide functions of the first communication device 1.

In one embodiment, the message processing systems (10, 20) include encoding modules (100, 200), transmitting modules (120, 220), receiving modules (130, 230), decoding modules (140, 240), and displaying modules (150, 250). The mentioned modules may be used to execute one or more operations for the message process system (10, 20).

The encoding module 100 retrieves the original image on the touch panel 12 of the first communication device 1, and encodes the original image to obtain a plurality of data packets. Each data packet has a protocol header comprising an allocated number of each data packet and an indication marking indicating the data packet belongs to the original image. In one embodiment, a format of the protocol header may be “05 00 03 XX MM NN”. In the protocol header, the byte “05” denotes that remain length of the protocol header is 5 after the byte “05”. The byte “00” denotes that the length of each packet is 1 byte. The byte “03” denotes that there are only 3 byte remain in the protocol header after the byte “03”. The indication marking may be denoted in the protocol header as the byte “XX,” indicating the data packet belongs to the original image. Furthermore, byte “MM” denotes the total number of the data packets, and the byte “NN” denotes the allocated number of the data packet. In one embodiment, the encoding module 100 encodes the original image via a Fax Group 3 (G3) algorithm to obtain the plurality of data packets.

The transmitting module 120 compresses the plurality of data packets to generate a message, and transmits the message to the second communication device 2 via the communication service provider 3. In one embodiment, the message may be a multimedia messaging service message.

The receiving module 230 in the second communication device 2 receives the message and stores the received message in the storage system 24.

The decoding module 240 decodes the received message which includes the plurality of data packets to obtain the original image. In one embodiment, the decoding module 240 decodes the received message by using one of the RS, Viterbi, Turbo algorithms, in one example.

The displaying module 250 displays the obtained original image on the touch panel 22 of the second communication device 2. As a result both the 1 and the 2 are able to display the original image.

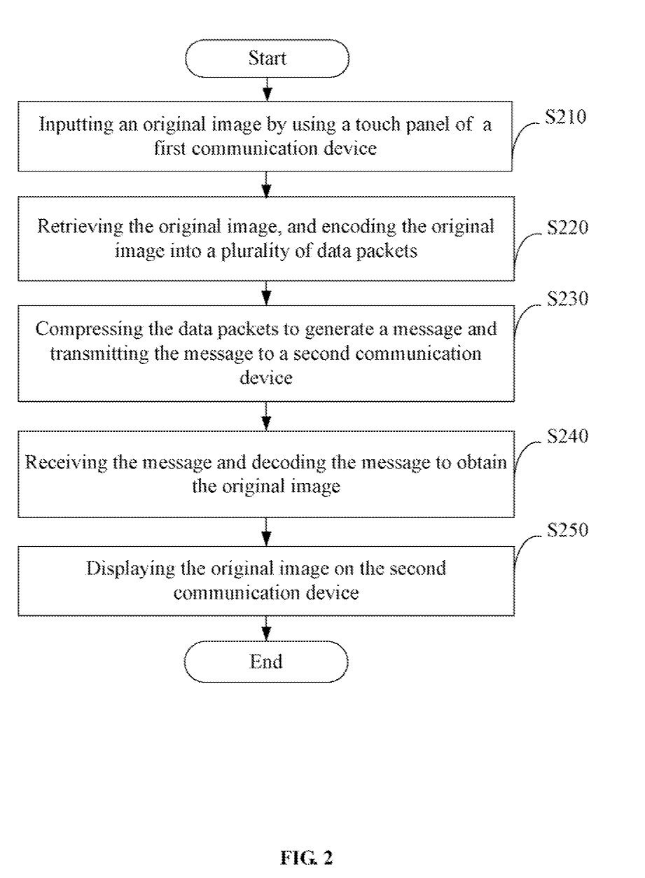

FIG. 2 is a flowchart of one embodiment of a method of processing message by using the first communication device 1 and the second communication device 2. Depending on the embodiment, additional blocks may be added, others removed, and the ordering of the blocks may be changed.

In block S210, the user of the first communication device 1 writes/draws an original image freely on the touch panel 12. For example, the original image may be the image 30.

In block S220, the encoding module 100 encodes the original image 30 into a plurality of data packets via a corresponding algorithm, such as the Fax Group 3 (G3) algorithm. Each data packet has a protocol header which has an allocated number of each data packet and an indication marking indicating the data packet belongs to the original image.

In block S230, the transmitting module 120 compresses the data packets to generate a message, and transmits the message to the second communication device 2 via the communication service provider 3. The message may be a multimedia messaging service message.

In block S240, the receiving module 230 of the second communication device 2 receives the transmitted message from the first communication device 1. The decoding module 240 decodes the received message to obtain the original image 32 by using a algorithm. As mentioned above, the algorithm may be the RS, Viterbi, Turbo algorithm, for example.

In block S250, the displaying module 2500 displays the decoded the original image 32 on the touch panel 22 of the second communication device 2.

FIG. 3 is a schematic diagram of the original image 30 input in the first communication device and the obtained original image 32. The first communication device 1 decodes the original image 30 into the plurality of data packets, and compresses the data packets to obtain the message, and transmitted the message to the second communication device 2. The second communication device 2 decodes the message to obtain the original image 32 and displays the obtained original image 32 on the touch panel 22. As a result both the 1 and the 2 are able to display the original image. Thus, amusement of sending message is greatly improved.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A message processing method using a first communication device and a second communication device, the first communication device comprising a touch panel, the method comprising:
inputting an original image by using the touch panel of the first communication device;
encoding the original image into a plurality of data packets, each data packet having a protocol header comprising an allocated number of each data packet and an indication marking indicating the data packet belongs to the original image;
compressing the data packets to generate a message, and transmitting the message to the second communication device;
receiving the message by the second communication device and decoding the message to obtain the original image; and
displaying the obtained original image on a display of the second communication device.

2. The method as claims in claim 1, wherein the original image is encoded via a Fax Group 3 (G3) algorithm.

3. The method as claims in claim 1, wherein the message is decoded via one of RS, Viterbi, Turbo algorithms.

4. A computer-based message processing system, the system comprising:
a storage system;
at least one processor; and
one or more programs stored in the storage system and being executable by the at least one processor, the one or more programs comprising:
an encoding module to retrieve an original image input of a first communication device and encode the original image into a plurality of data packets, each data packet having a protocol header comprising an allocated number of each data packet and an indication marking indicating the data packet belongs to the original image;
a transmitting module to compress the data packets to generate a message, and transmit the message to a second communication device;
a receiving module to receive the message and stored the received message by the second communication device;
a decoding module to decode the message to obtain the original image; and
a displaying module to display the obtained original image on a display of the second communication device.

5. The system as claimed in claim 4, wherein the encoding module encodes the original image via a Fax Group 3 (G3) algorithm.

6. The system as claimed in claim 4, wherein the decoding module decodes the message via one of RS, Viterbi, Turbo algorithms.

7. The system as claimed in claim 4, wherein the storage system is selected from the group consisting of a smart media card, a secure digital card, and a compact flash card.

8. A storage medium storing a set of instructions, the set of instructions capable of being executed by a processor to perform a message processing method using a first communication device and a second communication device, the first communication device having a touch panel, the method comprising:
inputting an original image by using the touch panel of the first communication device;
encoding the original images into a plurality of data packets, each data packet having a protocol header comprising an allocated number of each data packet and an indication marking indicating the data packet belongs to the original image;
compressing the data packets to generate a message, and transmitting the message to the second communication device;
receiving the message by the second communication device and decoding the message to obtain the original image; and
displaying the obtained original image on a display of the second communication device.

9. The storage medium as claimed in claim 8, wherein the original image is encoded via a Fax Group 3 (G3) algorithm.

10. The storage medium as claimed in claim 8, wherein the message is decoded via one of RS, Viterbi, Turbo algorithms.
